(19) United States
(12) Patent Application Publication
(10) Pub. No.: US 2018/0255793 A1
(43) Pub. Date: Sep. 13, 2018

(54) CASING FOR FOOD PRODUCTS

(71) Applicant: COLUMBIT (PTY) LTD, Cape Town (ZA)

(72) Inventors: Derrick George, Cape Town (ZA); Steven Broekhuysen, Cape Town (ZA)

(21) Appl. No.: 15/915,668

(22) Filed: Mar. 8, 2018

(30) Foreign Application Priority Data
Mar. 9, 2017 (ZA) 2017/01701

(51) Int. Cl. A22C 13/00; B32B 1/08; B32B 3/26; B32B 7/06; B32B 27/30; B32B 27/32; B32B 27/34; B32B 27/08

(52) U.S. Cl. CPC A22C 13/0013; A22C 2013/0086; B32B 3/266; B32B 7/06; B32B 27/308; B32B 27/32; B32B 27/34; B32B 27/08; B32B 2307/582; B32B 2439/70; B32B 2439/40; A22C 2013/003; A22C 2013/0036; A22C 2013/0053; A22C 2013/0059; A22C 2013/0063; A22C 2013/0043; B32B 1/08

(57) ABSTRACT

An elongate strip (10) is disclosed which can be manipulated into a cylindrical shape to form a casing for a food product. The strip comprises films of synthetic plastics material which are laminated together. One of the two outer films of the laminate is a peelable ionomer and the other is an olefin. A plurality of web weakening formations (18) for facilitating initiation of transverse tearing of the web are provided along one of the longitudinal edges of the web. The formations constitute the boundaries of a plurality of pull tabs (20). The weakening formations can be lines of perforations extending inwardly from said one edge of the web

### FIELD OF THE INVENTION

This invention relates to casings for food products.

### BACKGROUND TO THE INVENTION

Cooked meat products such as polony, liver sausage and salami are packaged in cylindrical casings which are closed at both ends by metal clips. The casings are often opened by the simple expedient of cutting through them, usually close to one end.

There is a demand for a food product of this configuration the casing of which contains one serving of the product and which casing can be opened without the use of a knife or other form of cutter. One use of such a product is to be included in a scholar's lunch box. Such a product can be opened by the scholar without the need for the scholar to find and use a cutter.

A casing which can be opened without the use of the knife or other cutter is disclosed in United States Patent Publication US 2002/0102375A1.

The casing disclosed is a laminate comprising three films. The outer films are of polypropylene and the centre film is a barrier film of Nylon. The peel strength between the outer film of polypropylene and the Nylon film is lower than the peel strength between the inner film of polypropylene and the Nylon film.

The casing is closed by a longitudinally extending overlap seal with a longitudinally extending pull strip protruding outwardly from the seal. Notches are provided in the edge of the pull strip.

To open the casing the pull strip is gripped and pulled towards the seal. The pull strip tears between two notches to form a tab. Because of the strength of the seal it does not fail when the tears resulting from the opening force exerted on the pull tab reach the seal. It is the film of polypropylene immediately adjacent the seal and on the inside of the seal which tears. The low peel force required to separate the torn film of polypropylene from the Nylon film permits these two films to be separated thereby to open the casing after the polypropylene film tears.

The different peel strengths between the layers is essential to permit this casing to be opened.

### BRIEF DESCRIPTION OF THE INVENTION

According to one aspect of the present invention there is provided an elongate strip which can be manipulated into a cylindrical shape to form a casing for a food product, the strip comprising films of synthetic plastics material which are laminated together, one of the two outer films of the laminate being a peelable ionomer and the other being an olefin, there being, along one of the longitudinal edges of the strip, a plurality of web weakening formations for facilitating initiation of transverse tearing of the web, the formations being the boundaries of a plurality of pull tabs.

The weakening formations can be lines of perforations extending inwardly from said one edge of the web, the sealing zone preferably being adjacent those ends of the lines of perforations which are remote from said one edge but not crossing the lines.

According a further aspect of the present invention there is provided a method of making a casing for a food product which comprises manipulating the strip defined in the preceding paragraphs into a cylindrical form with edge zones of the strip overlapping, and heat sealing the overlapped edge zones to one another along a sealing line spaced from said one edge, the olefin film being the inner film of the casing.

According to a further aspect of the present invention there is provided a casing for a food product which comprises a strip as defined above which has been manipulated to cylindrical form with the polyolefin layer as the inner layer and edge zones of the strip overlapping, there being a seal where said edge zones of the strip overlap, said one edge zone protruding outwardly from the seal so that said tabs are accessible from externally of the cylindrical casing.

### BRIEF DESCRIPTION OF THE DRAWINGS

For a better understanding of the present invention, and to show how the same may be carried into effect, reference will now be made, by way of example, to the accompanying drawings in which:

FIG. 1 illustrates, in lay flat form, a strip which can be formed into a cylindrical casing;

FIG. 2 a section on the line ii-ii of FIG. 1; and

FIG. 3 is a diagrammatic representation in the form of a section through a cylindrical casing in accordance with the present invention.

### DETAILED DESCRIPTION OF THE DRAWINGS

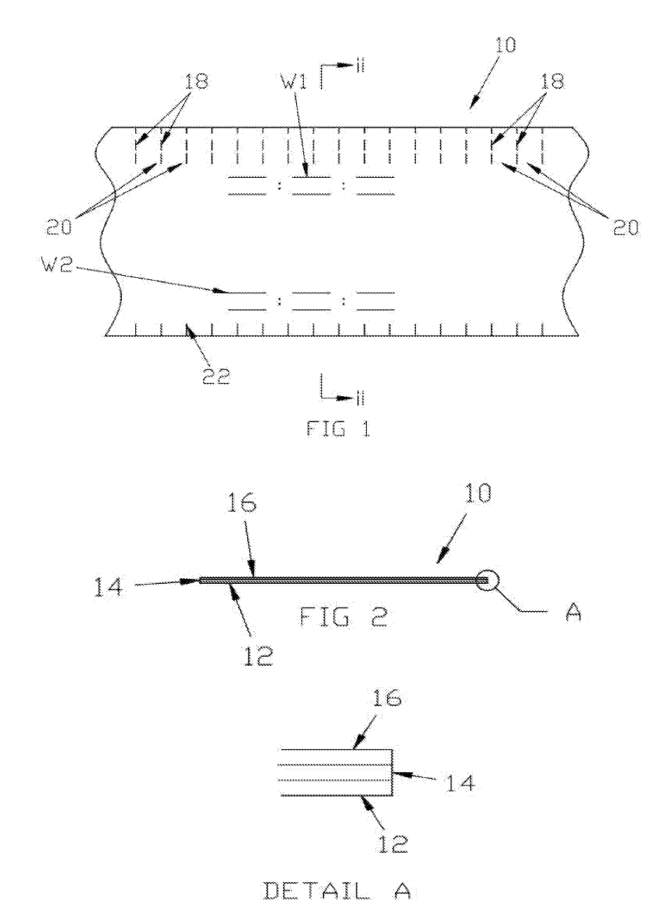

The strip 10 shown in FIG. 1 is a three film laminate comprising a polyolefin film 12, a polyamide film 14 and a third film 16 in the form of a peelable ionomer. The films are laminated with the polyamide between the polyolefin, which is preferably a polyethylene blend, and the peelable ionomer which is preferably Surlyn. Surlyn is the registered trade mark of DuPont.

The polyethylene blend can be of LLDPE and HDPE and is the inside layer when the strip is formed into a cylindrical casing. It is consequently the film which is in contact with the food product and has moisture barrier properties. The polyamide forms a barrier to oxygen transmission and also provides stretch and shrink characteristics to the laminate.

The peelable ionomer film constitutes the outside layer of the cylindrical casing.

One edge of the laminated strip is formed with lines of perforations designated 18. Each line 18 extends inwardly from one edge of the laminate. The lines 18 bound a plurality of pull tabs 20. The perforations constitute web weakening formations which facilitate initiation of transverse tearing on the web. The perforations can be replaced by notches in the edge of the web.

Further lines of perforations 22 are provided along the other edge of the laminate. Each line of perforations 22 is shorter than any of the lines 18.

As the strip is rolled to form a cylindrical casing by overlapping edge zones of the strip and forming an overlap seal, the polyethylene film 12 which is on the inside comes into contact with the peelable ionomer film 16 as shown in FIG. 2. The seal is formed along the sealing line 24 between the polyethylene and the ionomer.

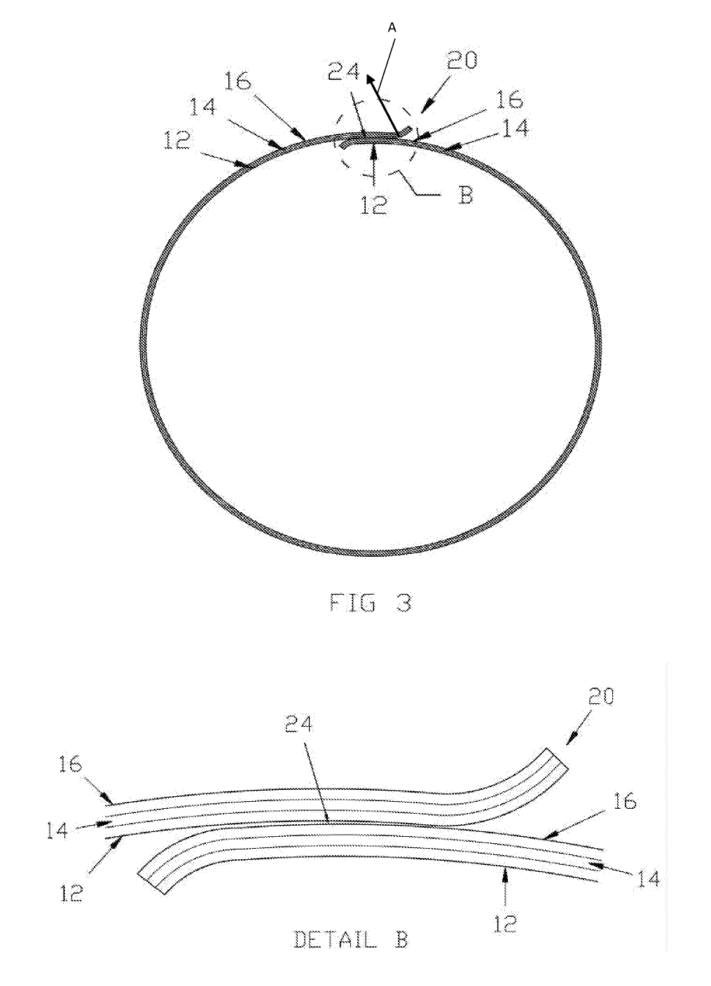

The parts of the strip where sealing takes place are shown at S1 and S2 in FIG. 1. It will be seen that they are positioned just inwardly of the lines of perforations 18, 22. Consequently the edge zone of the strip in which the perforations 18 are formed projects from the seal 24 as shown in FIG. 3.

It is possible to open a filled casing by prising up the free edge of the laminate, gripping one of the tabs 20, and pulling it in the direction of the arrow A in FIG. 3. The laminate tears along the perforations 18 which bound the tab 20 that is being pulled. Continuing to pull on the tab 20 results in the tear lines extending into the laminate beyond the ends of the perforations 18. Because of the nature of the seal between the films 12 and 16, the peeling action is not inhibited by the presence of the seal and the two films readily separate despite the presence of the seal. Eventually the tear lines extend substantially the whole way around the casing which then separates into two parts. This enables easy access to be had to the contents of the casing.

1. An elongate strip which can be manipulated into a cylindrical shape to form a casing for a food product, the strip comprising films of synthetic plastics material which are laminated together, one of the two outer films of the laminate being a peelable ionomer and the other being an olefin, there being, along one of the longitudinal edges of the strip, a plurality of web weakening formations for facilitating initiation of transverse tearing of the web, the formations being the boundaries of a plurality of pull tabs.

2. A strip as claimed in claim 1, wherein the weakening formations are lines of perforations extending inwardly from said one edge of the web, the sealing zone being adjacent those ends of the lines of perforations which are remote from said one edge but not crossing the lines.

3. A method of making a casing for a food product which comprises manipulating the strip claimed in claim 1 into a cylindrical form with edge zones of the strip overlapping, and heat sealing the overlapped edge zones to one another along a sealing line spaced from said one edge, the olefin film being the inner film of the casing.

4. A method of making a casing for a food product which comprises manipulating the strip claimed in claim 2 into a cylindrical form with edge zones of the strip overlapping, and heat sealing the overlapped edge zones to one another along a sealing line spaced from said one edge, the olefin film being the inner film of the casing.

5. A casing for a food product which comprises a strip as claimed in claim 1 which has been manipulated to cylindrical form with the polyolefin layer as the inner layer and edge zones of the strip overlapping, there being a seal where said edge zones of the strip overlap, said one edge zone protruding outwardly from the seal so that said tabs are accessible from externally of the cylindrical casing.
